(19) United States
(12) Patent Application Publication
(10) Pub. No.: US 2011/0052312 A1
(43) Pub. Date: Mar. 3, 2011

(54) JOINT INSTRUMENT SUPPORT ASSEMBLY

(75) Inventor: Ming-Yi Chang, Taichung (TW)

(73) Assignee: REMARKABLE COMPANY, Taichung City (TW)

(21) Appl. No.: 12/549,481

(22) Filed: Aug. 28, 2009

(51) Int. Cl. F16C 11/10

(52) U.S. Cl. 403/65

(57) ABSTRACT

A joint instrument support assembly is disclosed. Both sides of a rotating elbow have an ear part, respectively. A groove is formed between the two ear parts. One ear part communicates with the groove via a circular hole. The two ear parts have a circular wall toward the groove, respectively. A rotating block is disposed in the rotating elbow. A rod goes through the rotating block. A limiting element locks on the rod and positions in the axle hole to rotate with respect to the rotating block. A sliding block having a through hole and an outer thread part is disposed in an accommodating room. A pad is mounted on the outer thread part and strides across the outer edges of the two circular walls. A fastening element locks onto the outer thread part outside the pad.

### BACKGROUND OF THE INVENTION

1. Field of Invention

The invention relates to a joint instrument support assembly and, in particular, to a structure that is disposed on the base of an instrument support and connects to the instrument.

2. Related Art

As shown in FIG. 21, a conventional instrument support assembly has a rotating elbow 80 connecting a cymbal 81 to the support frame 82 for adjusting the orientation thereof The rotating elbow 80 has an elbow base 801 fixed to the rod 82 of the support frame. A rotating block 802 connects to the cymbal 81. The elbow base 801 and the rotating block 802 engage with each other by teeth. When they are released, one can adjust the angle between the cymbal 81 and the support frame. When they are fastened, the angle is fixed.

However, in the above-mentioned instrument support assembly, to adjust the angle of the rotating elbow 80 relative to the elbow base 801, one has to engage the teeth of the rotating block 802 and the elbow base 801 in order to fix it. The engaging positions of the teeth have a fixed span. Therefore, one cannot arbitrarily change the angle and fix it. This is a restriction. Besides, the elbow base 801 is fixed on the rod 82 of the support frame. Thus, to adjust the cymbal 81 horizontally, one has to release the rod 82 on the support frame and rotate the rod 82 for the cymbal 81 to rotate to the left or right. Therefore, rotating the cymbal 81 with respect to a vertical axis and a horizontal axis have to be done separately. This usually involves several adjustments back and forth in order to find a best orientation. It is very time-consuming.

FIG. 22 shows another conventional instrument support assembly, used to join a big drum and a small drum in a drum set. The big drum connects to a rotating elbow 91 and then to the small drum via a base 90. As shown in the drawing, to adjust the position of the small drum, one has to relax the base 90 in order to rotate with respect to a vertical axis. One has to relax the rotating elbow 91 in order to rotate the small drum with respect to a horizontal axis. So the adjustments still have to be done several times separately. It is still quite inconvenient.

Consequently, both of the above-mentioned two conventional instrument support assemblies have the problem of inconvenient in adjustments. It is thus an objective of the invention to solve this problem.

### SUMMARY OF THE INVENTION

In view of the foregoing, the invention provides a joint instrument support assembly to make the orientation adjustment of an instrument on the support frame more quickly.

The disclosed joint instrument support assembly includes: a rotating elbow, a cylindrical rotating block, a sliding block, a pad, and a fastening element.

Both sides of the rotating elbow have an ear part, respectively. A groove is formed between the two ear parts. One ear part has a circular hole to communicate with the groove. Both ear parts are formed respectively with a circular wall toward the groove. The circular walls are symmetric and have an outer diameter larger than the circular hole.

The cylindrical rotating block goes from the circular hole of the ear part through the groove and urges against the other ear part. It is restricted to rotate within the two circular walls. The rotating block goes through an accommodating room along the radial direction. The rotating block is formed with an axle hole through a sidewall of the accommodating room. The other sidewall has a recess. The rotating block is formed at the bottom of the recess with a connecting hole. A rod on the instrument support frame goes via the axle hole into the rotating block. It goes through the accommodating room and into the recess. The rod urges against the bottom of the recess by its end surface. The end surface of the rod has a screw hole. A limiting element with an outer thread goes through the connecting hole and fastens in the screw hole. This positions the rod and allows it to pivotally rotate within the rotating block.

The sliding block is disposed in the accommodating room to shift forward and backward. The sliding block has a through hole corresponding to the axle hole and for the rod to go through. It further has an outer thread part protruding toward the rotating block.

The pad is disposed on the outer thread part, with its two ends striding on the edges of the two circular walls. It is allowed to slide along the arcs of the two circular walls.

The fastening element is locked on the outer thread part outside the pad. It guides the sliding block to move within the accommodating room and urge the rod against the rotating block.

### BRIEF DESCRIPTION OF THE DRAWINGS

The invention will become more fully understood from the detailed description given herein below illustration only, and thus is not limitative of the present invention, and wherein:

FIG. 1 is a three-dimensional view of the first embodiment in use;

FIG. 2 is a three-dimensional perspective view of the first embodiment;

FIG. 3 is a three-dimensional exploded view of the first embodiment;

FIG. 4 is a cross-sectional view of the connected rod in the first embodiment;

FIG. 5 is a cross-sectional view of the released rod in the first embodiment;

FIG. 6 shows the rotation with respect to a vertical axis in the first embodiment;

FIG. 7 shows the rotation with respect to a horizontal axis in the first embodiment;

FIG. 8 is a cross-sectional view of the urging rod in the first embodiment;

FIG. 9 is a three-dimensional view of the second embodiment in use;

FIG. 10 shows the rotation with respect to a vertical axis in the second embodiment;

FIG. 11 shows the rotation with respect to a horizontal axis in the second embodiment;

FIG. 12 is a three-dimensional view of the third embodiment in use;

FIG. 13 shows the positioning state of the third embodiment;

FIG. 14 shows the rotation with respect to a vertical axis in the third embodiment;

FIG. 15 shows the rotation with respect to a horizontal axis in the third embodiment;

FIG. 16 is a three-dimensional view of the fourth embodiment in use;

FIG. 17 shows the positioning state of the fourth embodiment;

FIG. 18 is a cross-sectional view of the connected rod in the fourth embodiment;

FIG. 19 shows the rotation with respect to a vertical axis in the fourth embodiment;

FIG. 20 shows the rotation with respect to a horizontal axis in the fourth embodiment;

FIG. 21 is an exploded view of the components in a conventional instrument support assembly; and

FIG. 22 is a three-dimensional view of another conventional instrument support assembly.

### DETAILED DESCRIPTION OF THE INVENTION

The present invention will be apparent from the following detailed description, which proceeds with reference to the accompanying drawings, wherein the same references relate to the same elements.

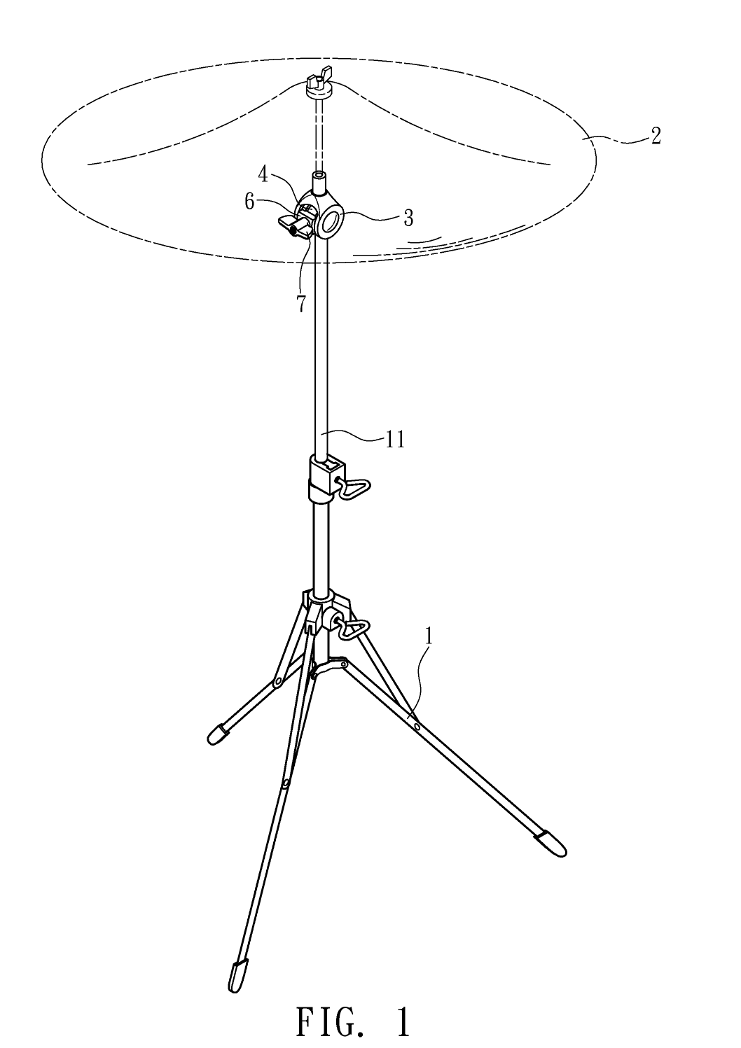

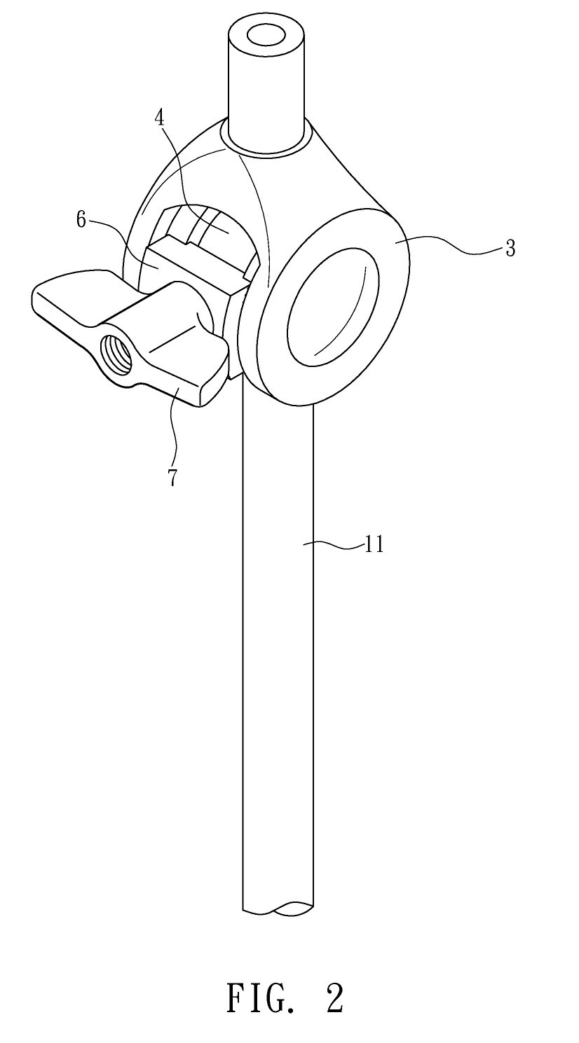

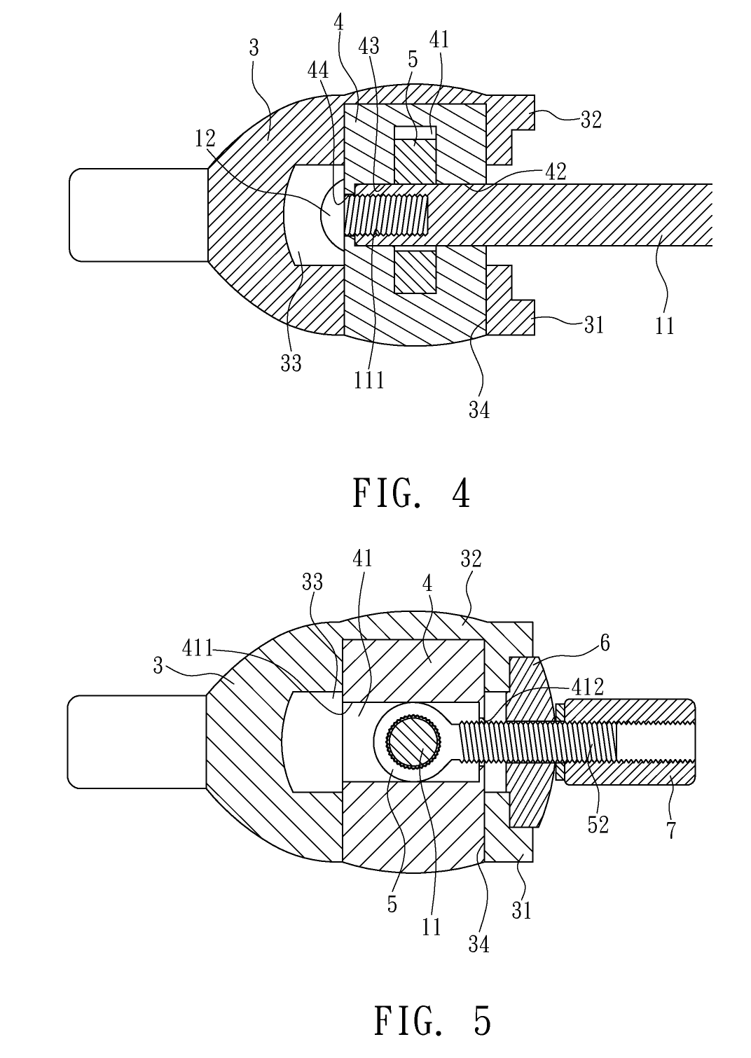

Please refer to FIGS. 1 to 5 for a first embodiment of the invention. This is only an illustration and should not be used to restrict the scope of the invention.

This embodiment provides a joint instrument support assembly for a vertical support frame 1 to fix and adjust a cymbal 2. It includes: a rotating elbow 3, a cylindrical rotating block 4, a sliding block 5, a pad 6, and a fastening element 7.

Both sides of the rotating elbow 3 have an ear part 31, 32, respectively. A groove 33 is formed between the two ear parts 31, 32. The ear part 31 has a circular hole 34 to communicate with the groove 33. Both ear parts 31, 32 are formed respectively with a circular wall 35 toward the groove 33. The outer edges 351 of the circular walls 35 are symmetric and have an outer diameter larger than the circular hole 34.

The cylindrical rotating block 4 goes from the circular hole 34 of the ear part 31 through the groove 33 and urges against the other ear part 32. It is restricted to rotate within the two circular walls 35. The rotating block 4 goes through an accommodating room 4 and an axle hole 42 along the radial direction. The accommodating room 41 and the axle hole 42 are roughly perpendicular to each other. One rod 11 connected with the instrument or support frame goes through the axle hole 42 into the rotating block 4. The rod 11 goes through the accommodating room 41 and connects to the rotating block 4. The rod 11 can rotate with respect to the rotating block 4.

On the rotating block 4, the axle hole 42 goes out of a sidewall of the accommodating room 41. The other sidewall has a recess 43. A connecting hole 44 goes through the bottom of the recess 43. A rod is mounted on the support frame 1 of the cymbal 2. The rod 11 goes via the axle hole 42 into the rotating block 4. It goes through the accommodating room 41 and into the recess 43. The rod 11 urges against the bottom of the recess 43 by its end surface. The end surface of the rod 11 has a screw hole 111. A limiting element 12 with an outer thread part 121 goes through the connecting hole 44 and fastens in the screw hole 111. This positions the rod 11 and allows it to pivotally rotate within the rotating block 4.

The sliding block 5 is disposed in the accommodating room 41 to shift forward and backward. The sliding block 5 has a through hole 51 corresponding to the axle hole 42 and for the rod 11 to go through. It further has an outer thread part 52 protruding toward the rotating block 4.

The pad 6 is disposed on the outer thread part 52, with its two ends striding on the edges 351 of the two circular walls 35. It is allowed to slide along the arcs of the two circular walls 35.

The fastening element 7 is locked on the outer thread part 52 outside the pad 6. It guides the sliding block 5 to move within the accommodating room 41 and urge the rod 11 against the rotating block 4.

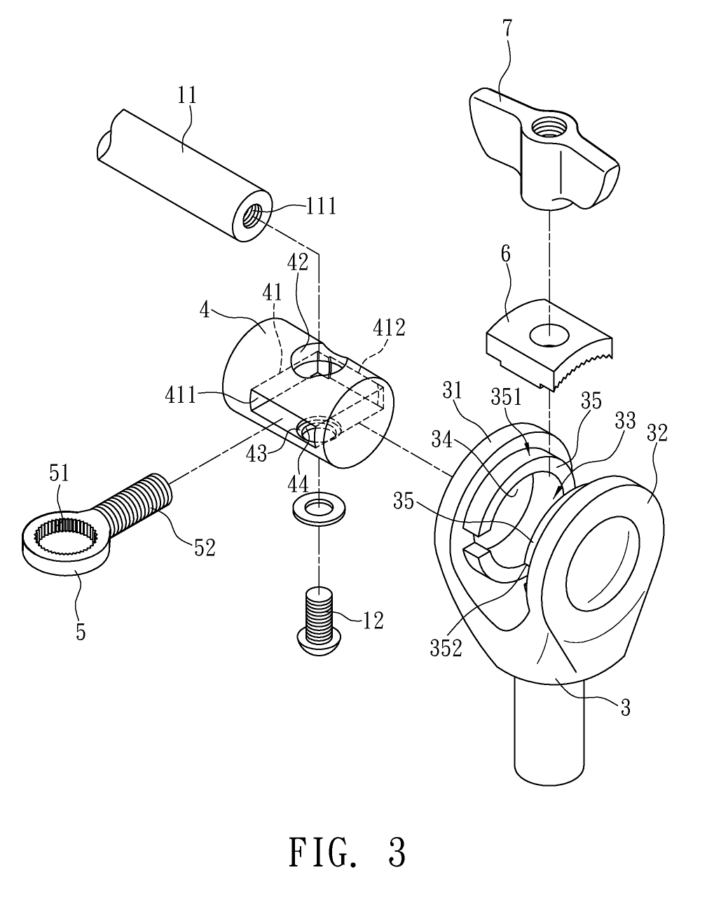

As shown in FIG. 3, the rotating block 4 has an inlet 411 and an outlet 412 on one end of the accommodating room 41. The inlet 411 is larger than the width of the sliding block 5, so that the sliding block 5 can enter the accommodating room 41. The outlet 412 is smaller than the width of the sliding block 5 for the outer thread part 52 to extend out. On the rotating elbow 3 of the embodiment, a notch 352 is formed on the corresponding positions on the two circular walls 35, respectively. The two notches 352 can correspond to the inlet 411 of the accommodating room 41 as the rotating block 4 rotates. In that case, the sliding block 5 can enter the accommodating room 41 of the rotating block 4.

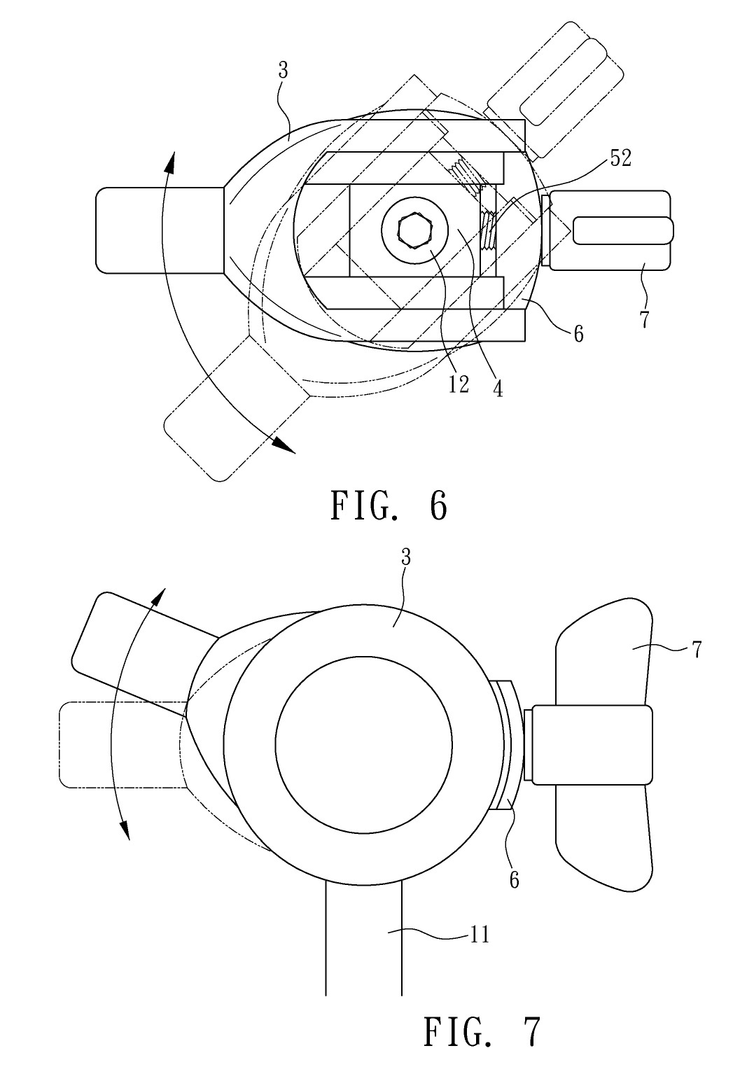

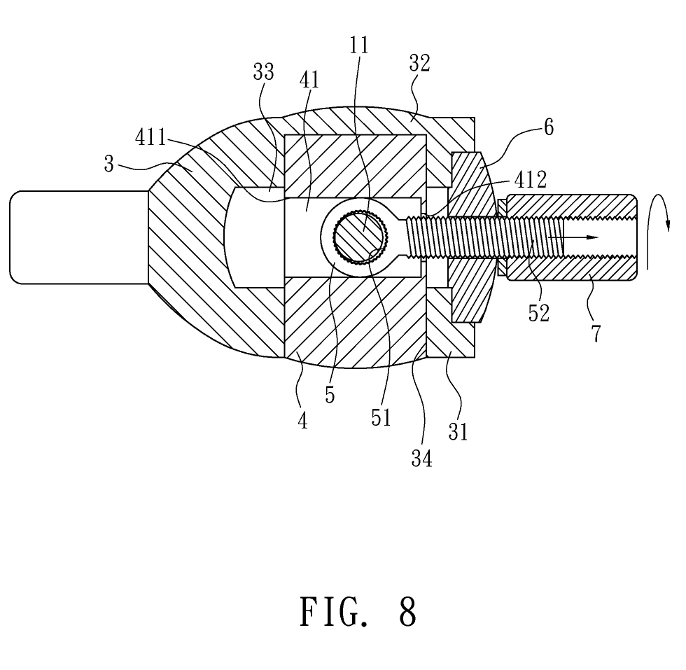

As shown in FIG. 5, when the fastening element 7 is relaxed, the sliding block 5 is loose in the rotating elbow 3. As shown in FIG. 6, the rotating elbow 3 can freely rotate on the rod 11. Moreover, the pad 6 and the rotating elbow 3 are relaxed. Therefore, the rotating elbow 3, as shown in FIG. 7, can freely swing up and downs relative to the rotating block 4. The rotating elbow 3 allows the simultaneous adjustments of the cymbal 2 in the vertical and horizontal directions of the rod 11 of the support frame 1. After the adjustments, one fastens the fastening element 7, as shown in FIG. 8. In this case, the sliding block 5 in the accommodating room 41 of the rotating block 4 is driven to urge the rod 11 against the rotating block 4. The pad 6 is urged by the fastening element 7 against the edges 351 of the two circular walls 35. Therefore, the rotating elbow 3 is positioned in the horizontal and vertical directions relative to the rod 11.

In comparison with the conventional instrument support assembly, the disclosed rotating elbow 3 does not involve any tooth structure. Thus, the rotating elbow 3 does not have limitation in angle, rendering a better freedom. Moreover, the disclosed rotating elbow 3 allows the simultaneous adjustment of the cymbal 2 in the horizontal and vertical directions relative to the rod 11. Therefore, one does not need to adjust several times as in the prior art. This largely shortens the adjusting time, making the adjustment easy and fast.

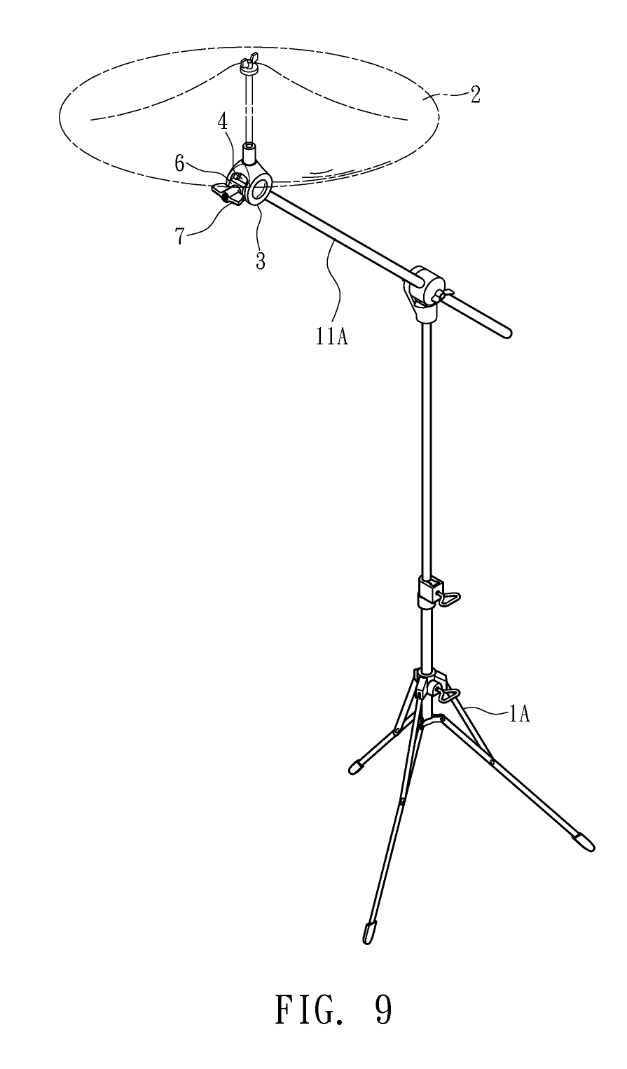

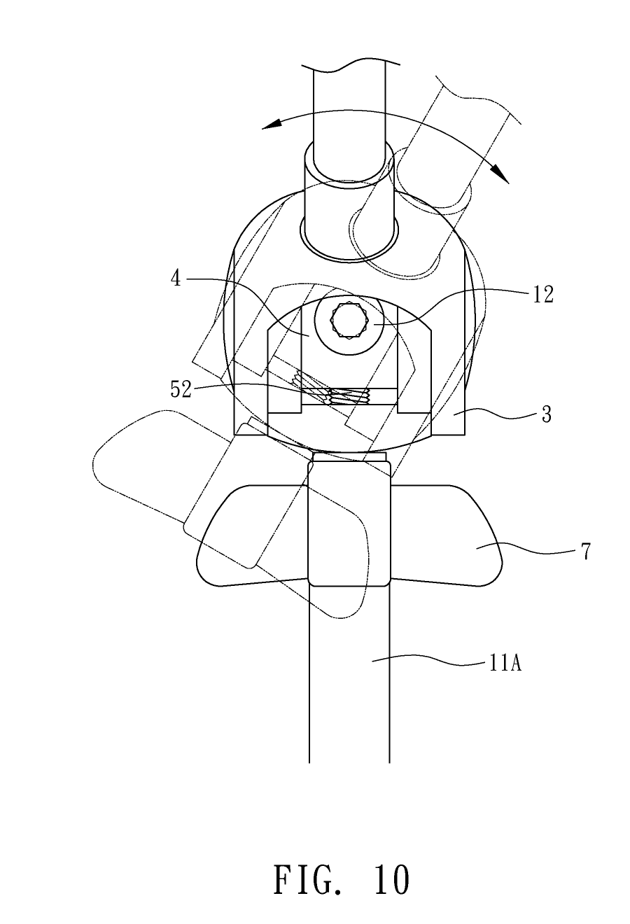

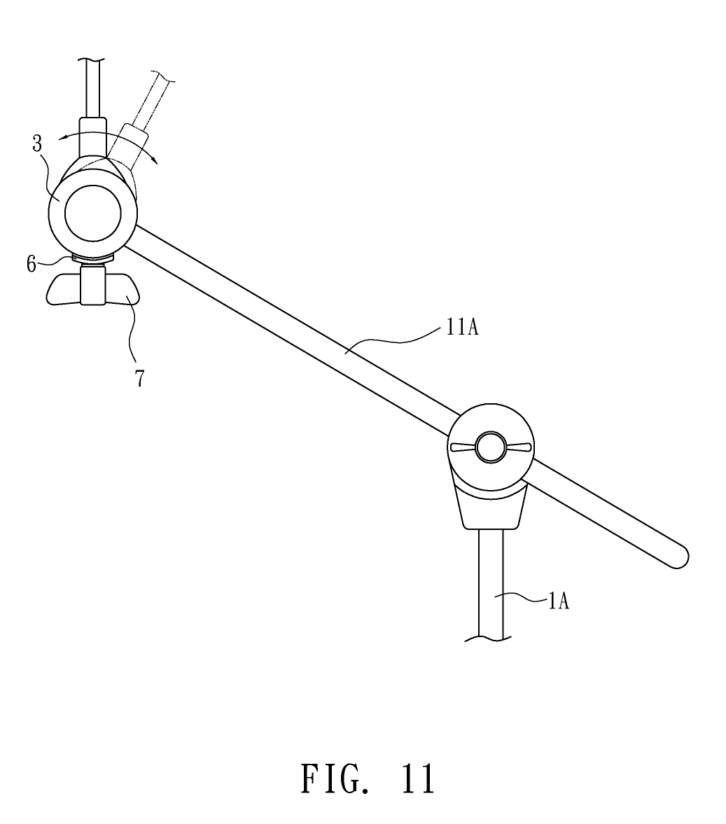

Of course, the invention has many other embodiments that differ only in details. Please refer to FIG. 9 for a second embodiment of the invention. The disclosed rotating elbow 3 can be used on a tilt support frame 1A. The rod 11A of the support frame IA can extend or retract. As shown in FIGS. 10 and 11, the rotating elbow 3 allows the simultaneous adjustment of the cymbal 2 in the horizontal and vertical directions relative to the rod 11A.

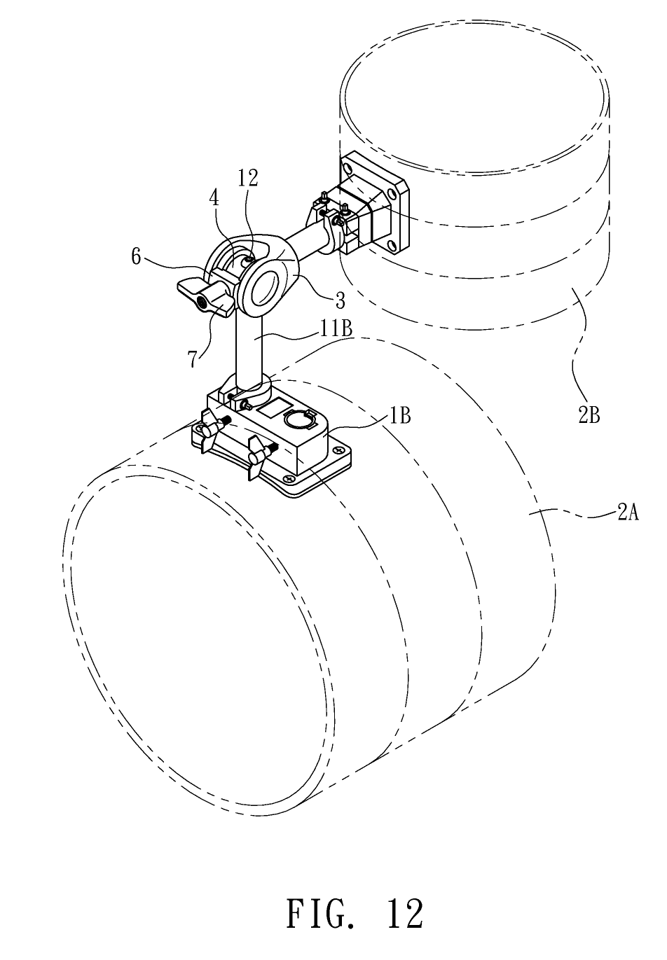

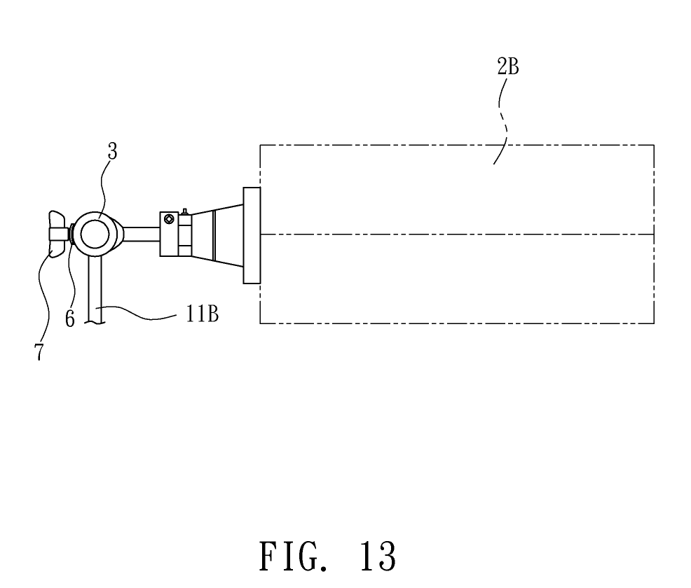

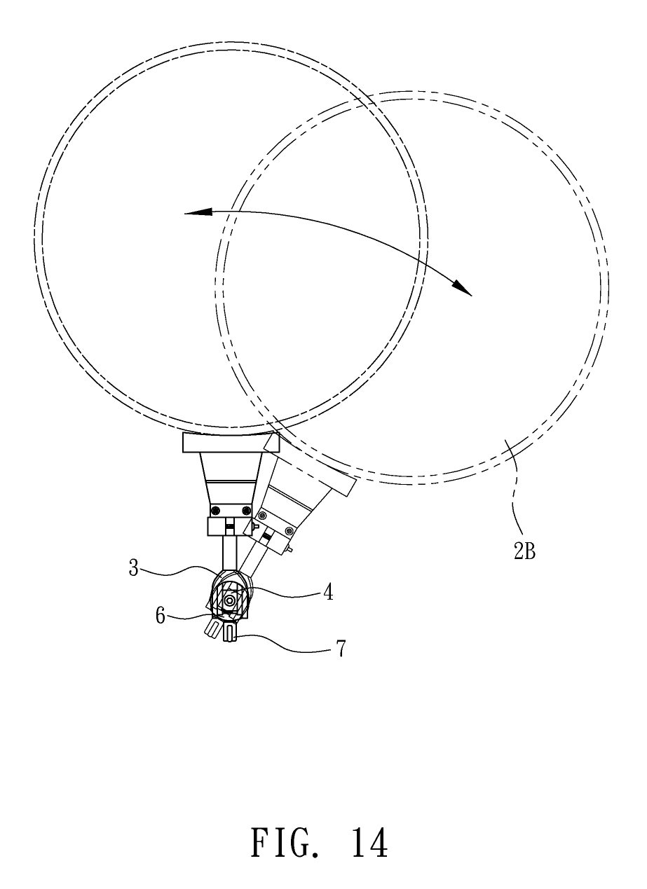

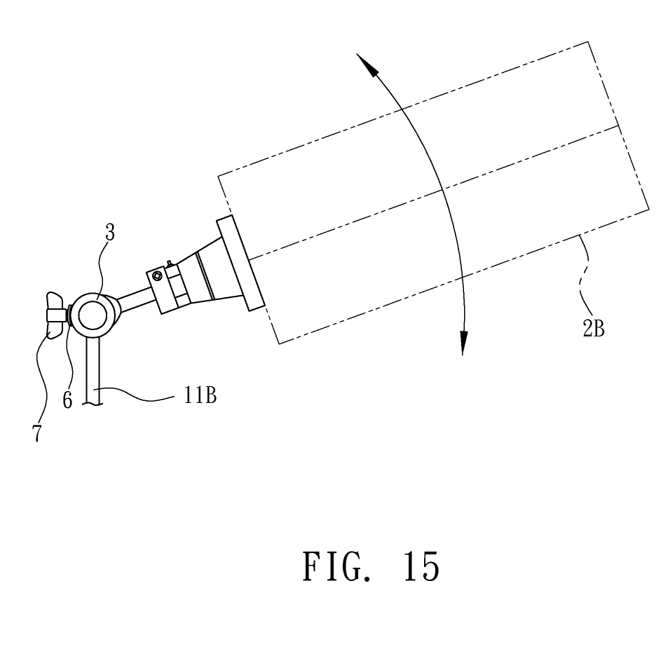

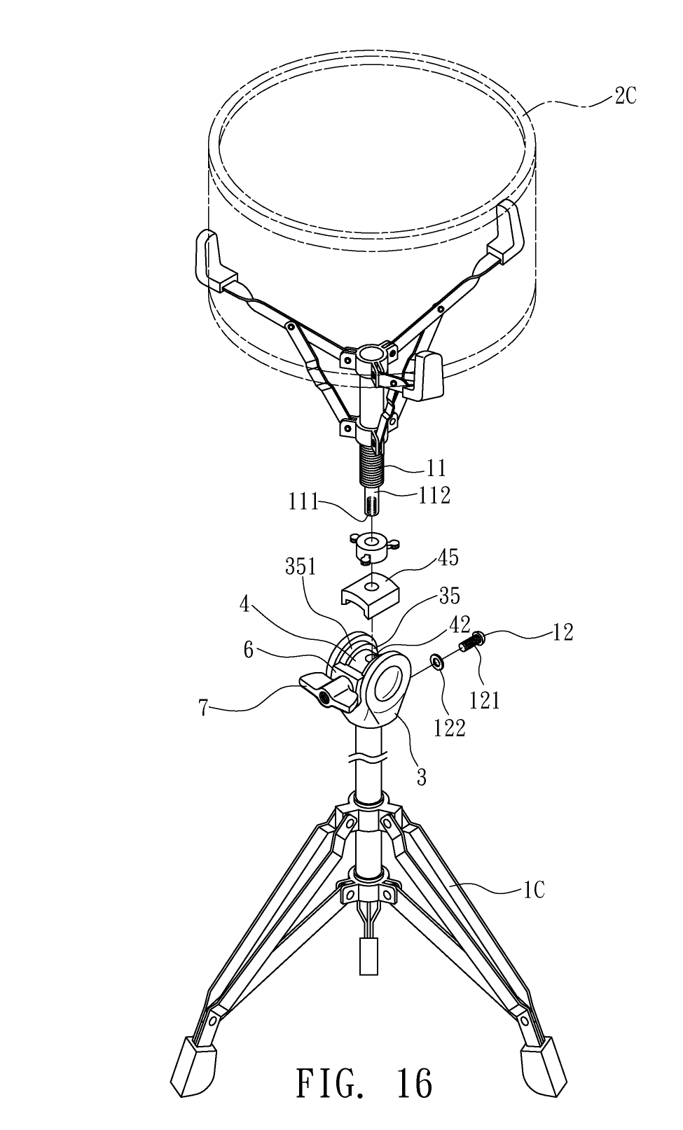

Please refer to FIGS. 12 and 13 for a third embodiment of the invention. The disclosed rotating elbow 3 can also be used to connect a big drum 2A and a small drum 2B. As shown in FIGS. 14 and 15, the support frame 1B connects to the rotating elbow 3 via the rod 11B. One simply loosens the fastening element 7 to adjust the horizontal and vertical positions of the small drum 2B. Unlike the conventional support assembly where one has to loosen the base to adjust the elbow base, this embodiment makes the adjustment easier and thus saves adjustment time.

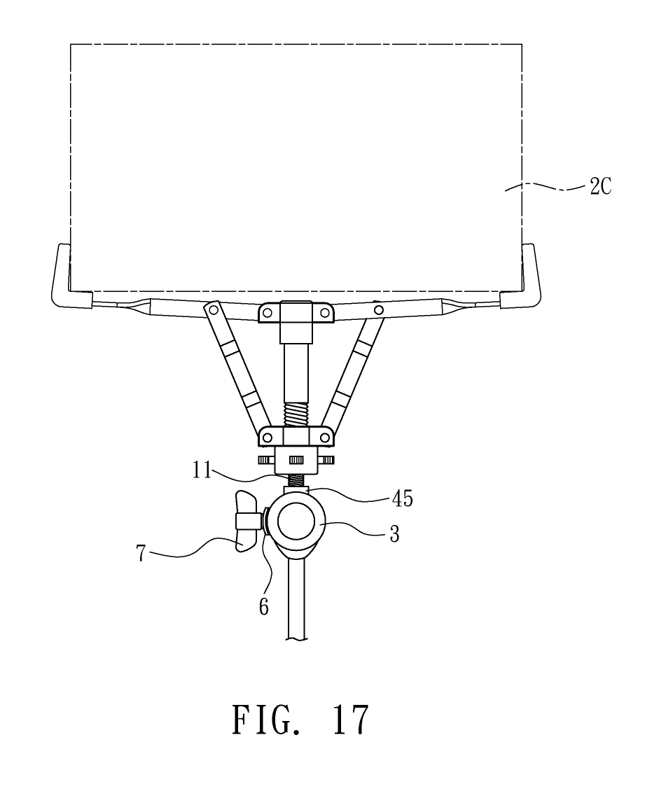

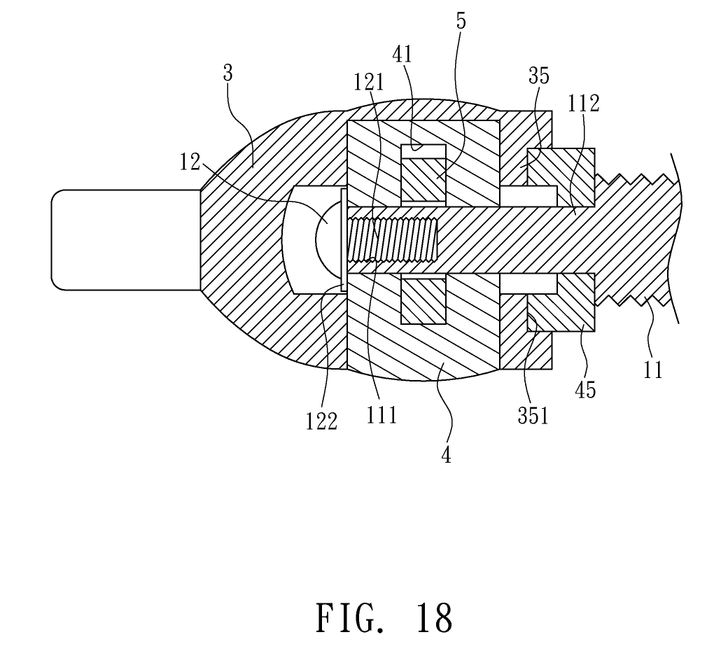

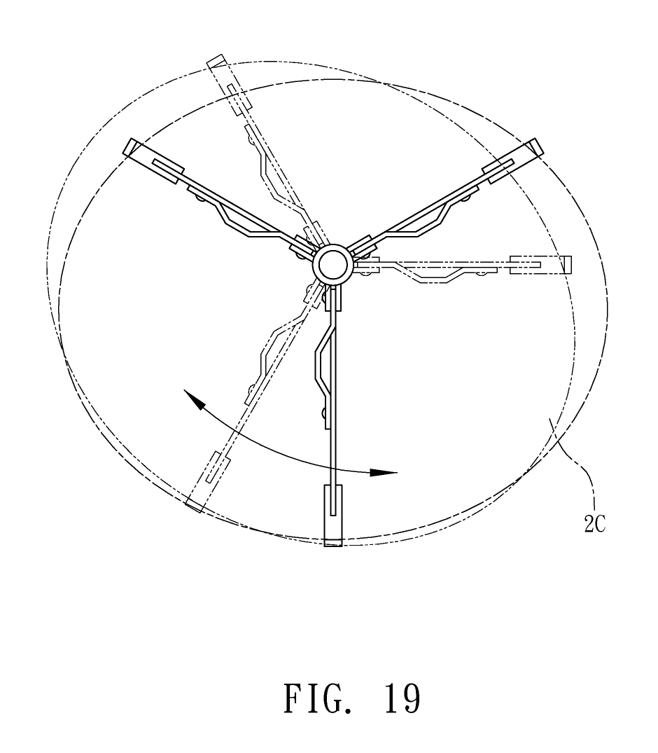

Please refer to FIGS. 16 to 18 for a fourth embodiment of the invention. The axle hole 42 of the rotating block 4 has a uniform diameter throughout. A stopping block 45 also strides across the outer edges 351 of the two circular walls 35 with the pad 6. One end of the rod 11 has a small-diameter section 112 whose diameter is the same as the axle hole 42. The small-diameter section 112 goes through the stopping block 45 into the axle hole 42. One end surface of the rod 11 has a screw hole 111. A limiting element 12 with an outer thread part 121 is fastened in the screw hole 111 to restrict the rod 11 to rotate in the rotating block 4. There is a small gap between the rod 11 and the rotating block 4 for the rod 11 to rotate therein more easily.

The small-diameter section 112 of the rod 11 in this embodiment is slightly longer than the axle hole 42 of the rotating block 4. The limiting element 12 uses its outer thread part 121 to go through a pad 122 and locks onto the screw hole 111 of the rod 11. The annular diameter of the pad 122 is greater than the axle hole 42.

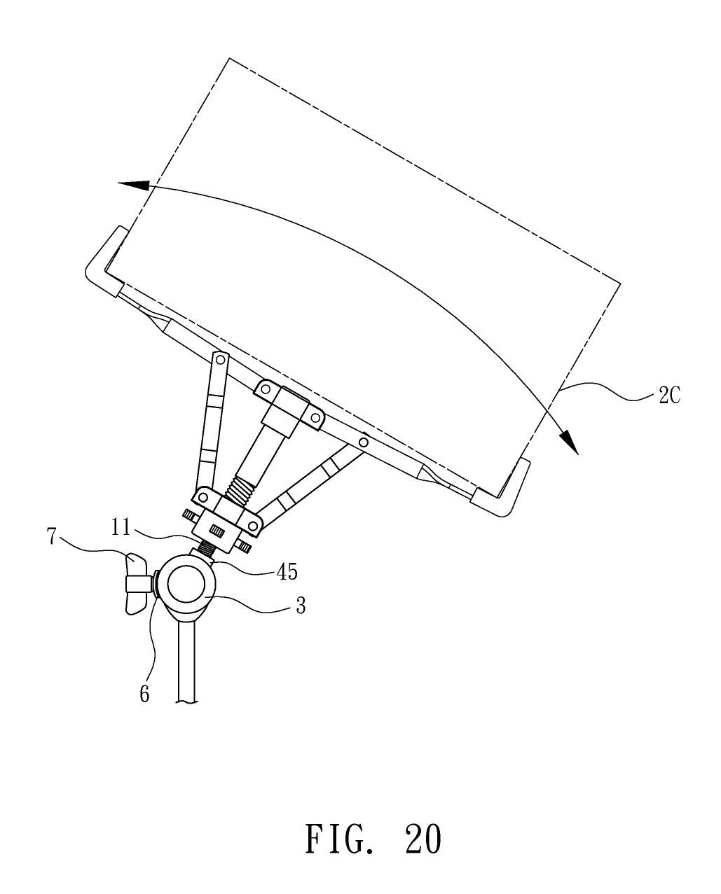

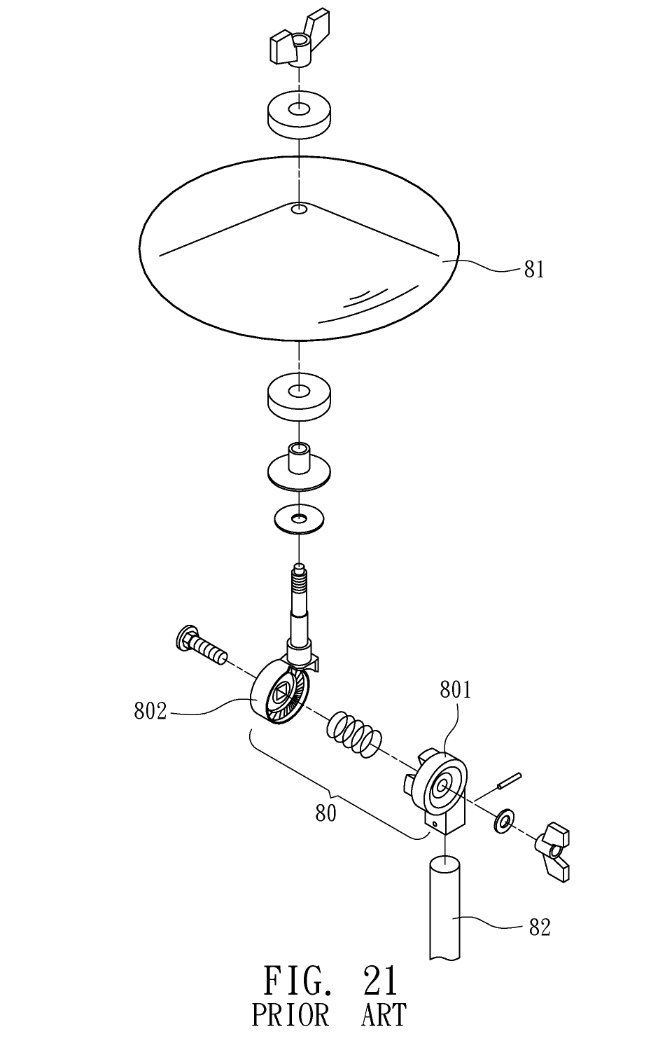

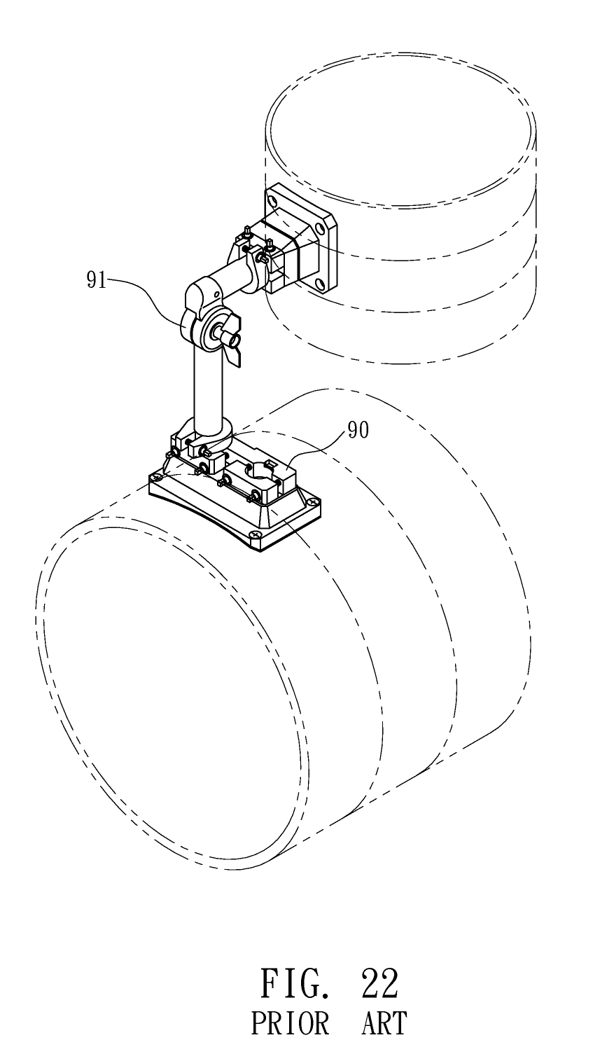

As shown in FIGS. 19 and 20, the disclosed rotating elbow 3 is used on the support frame 1C for the disposition of the small drum 2C. The support frame 1C connects to the rotating elbow 3 via the rod 11. Through the adjustments of horizontal and vertical positions of the rotating elbow 3, the small drum 2C on the support frame 1C can be quickly arranged to a position preferred by the user.

From the above description of various embodiment, the disclosed joint instrument support assembly is seen to have very wide applications. In addition to the embodiments disclosed herein, other supports whose vertical and horizontal positions need to be adjusted can be achieved quickly and conveniently using the disclosed rotating elbow.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A joint instrument support assembly, comprising:
a rotating elbow, whose both sides have an ear part, respectively, with a groove formed in between, one ear part having a circular hole to communicate with the groove and the two ear parts having symmetric circular walls toward the groove with the outer diameter of the circular wall greater than the circular hole;
a cylindrical rotating block, which goes via the circular hole of the ear part through the groove to urge against the other ear part and rotates within the two circular walls; wherein the rotating block goes through an accommodating room and an axle hole in the radial direction, with the two directions roughly perpendicular to each other; a rod in connection with an instrument or support frame goes via the axle hole into the rotating block; and the rod goes through the accommodating room to connect to the rotating block and rotates therein;
a sliding block, which is disposed in the accommodating room to move forward and backward, has a through hole corresponding to the axle hole for the rod to go through, and is protruded with an outer thread part toward the rotating block;
a pad, which is mounted on the outer thread part with its two end striding across the outer edges of the two circular walls for sliding along the arcs thereof; and
a fastening element, which locks onto the outer thread part outside the pad and guides the sliding block to move within the accommodating room, thereby urging the rod to the rotating block.

2. The joint instrument support assembly of claim 1, wherein the axle hole goes from the rotating block through one sidewall of the accommodating room, the opposite sidewall has a recess, connecting hole goes through the bottom of the recess, the rod goes via the rod through the accommodating room and into the recess, the rod urges against the bottom of the recess by its end surface, the end surface has a screw hole, and a limiting element with an outer thread part goes through the connecting hole and locks into the screw hole.

3. The joint instrument support assembly of claim 1, wherein the axle hole goes through the rotating block at a uniform diameter, a stopping block also strides across the outer edges of the two circular walls with the pad, one end of the rod has a small-diameter section whose diameter is the same as the axle hole, the small-diameter section goes through the stopping block into the axle hole, the rod has a screw hole on its end surface, a limiting element with an outer thread part locks in the screw hole to restrict the rod inside the rotating block, and a gap exists between the rod and the rotating block for the rod to rotate therein.

4. The joint instrument support assembly of claim 3, wherein the length of the small-diameter section of the rod is slightly longer than the axle hole of the rotating block, the limiting element goes through a pad by its outer thread part and locks in the screw hole of the rod, and the annular diameter of the pad is greater than the axle hole.

5. The joint instrument support assembly of claim 1, wherein the rotating block has an inlet on one end of the accommodating room that is larger than the width of the sliding block and an outlet on the other end that is smaller than the width of the sliding block.

6. The joint instrument support assembly of claim 1, wherein the two circular walls of the rotating elbow have respectively a notch at corresponding positions, the two notches correspond to the inlet of the accommodating room as the rotating block rotates, and the sliding block is disposed in the accommodating room of the rotating block.
